(19) United States
(12) Patent Application Publication
(10) Pub. No.: US 2012/0050314 A1
(43) Pub. Date: Mar. 1, 2012

(54) Automatic split-screen controller

(75) Inventor: Yu-Shan Wang, Taipei (TW)

(73) Assignee: Panavio Technology Limited

(21) Appl. No.: 12/807,283

(22) Filed: Sep. 1, 2010

(51) Int. Cl. G09G 5/00

(52) U.S. Cl. 345/619

(57) ABSTRACT

An automatic split-screen controller has a main controller, an image input port connected to a graphics card and a plurality of image output ports connected to corresponding display devices. After detecting that the display devices and the graphics card are connected with the image input and output ports, the main controller executes an automatic frame dividing process to obtain a resolution in an EDID of each of the display devices, sum up the resolutions to store a total of the resolution in a dynamic EDID, divide image data received from the graphics card and complying with the total of the resolutions into a plurality of frames, and respectively output the frames to the corresponding image output ports. Accordingly, the present invention can automatically detect and drive a plurality of display devices to display image data with split screens.

### BACKGROUND OF THE INVENTION

1. Field of the Invention

The present invention is related to an image processing device, and more particularly to an automatic split-screen controller.

2. Description of the Related Art

Due to size and specification, regular computer display devices have an optimized resolution and a refresh rate that they can support. Meanwhile, drivers of graphic cards are usually built in with a basic static display mode containing color depths and resolutions set up by manufacturers of graphics cards. For example, if a 32-bit color quality is desired, resolutions supported by graphics cards include 640×480, 800×600, 1024×768, 1280×1024 and 1600×1200. When a graphics card is connected with a display device, the graphics card first communicates with the display device to retrieve a set of extended display identification data (EDID) stored in a memory, such as PROM or EEPROM, of the display device. The generic timing parameters in the EDID include horizontal front porch, horizontal back porch, horizontal sync width, vertical front porch, vertical back porch, vertical sync width and the like.

Conventional graphics cards are normally used in collaboration with a single display device for single-screen display and are not tailored for outputting image data to multiple display devices for a split-screen demonstration. Consequently, some vendors have developed external split-screen controllers that are connected between a graphics card and a plurality of display devices. Users further go through a computer equipped with the graphics card to execute a driver of the external split-screen controller for setting split-screen parameters in the external split-screen controller based on parameters configured in the multiple display devices. As far as resolution parameters are concerned, users must first configure the resolution of each split screen in the external split-screen controller after executing the driver and satisfy the resolution parameter of each one of the display devices. Then, the split-screen controller receives image data from the graphics card, and image data for the split screens are smoothly divided and outputted to the corresponding display devices to demonstrate the complete image data on the split screens.

Although a single graphics card connected with a plurality of display devices through the split-screen controller can display image data transmitted from the graphics card on the split screens formed by the display devices, users must execute the driver of the split-screen controller in a computer to set up the required parameters for a split-screen display on multiple display devices. Such process is tedious and complicated. Besides, for users not quite understanding how to match up relevant parameters set up for the graphics card and the multiple display devices, it is beyond users to adequately set up those split-screen parameters with the driver.

### SUMMARY OF THE INVENTION

An objective of the present invention is to provide an automatic split-screen controller.

To achieve the foregoing objective, the automatic split-screen controller has a main controller, a memory unit, an image input port and a plurality of image output ports.

The main controller is built in with an automatic frame dividing process for automatically dividing a plurality of image frames.

The memory unit is electrically connected with the main controller for storing a set of dynamic extended display identification data (EDID) having horizontal front porch, horizontal back porch, vertical front porch and vertical back porch, and for storing image data.

The image input port is electrically connected with the main controller and adapted to connect with an output port of a graphics card.

The image output ports are electrically connected with the main controller. Each one of the image output ports is adapted to connect with an input port of one of a plurality of display devices to output one of the divided image frames to the input port of the display device.

After automatically detecting that at least two of the image output ports are connected with the corresponding display devices and the image input port is connected with the graphics card, the main controller executes the automatic frame dividing process having steps of:

reading a set of EDID stored in each one of the at least two display devices;

acquiring a resolution parameter from each one of the at least two sets of EDID;

summing all resolution parameters to generate and store a set of dynamic EDID having the total of the resolution parameters in the first memory;

outputting the set of dynamic EDID generated in the step of summing all resolution parameters to the graphics card;

receiving and storing image data from the graphics card;

dividing the image data in accordance with the resolution parameters of the at least two display devices to generate at least two frames corresponding to the at least two display devices; and

respectively outputting the frames to the image output ports connected to the at least two display devices.

The automatic split-screen controller can automatically retrieve the EDID of each display device connected therewith, sum up the resolution parameters of all display devices, and output the total of the resolution parameters to the graphics card through the image output port so that the graphics card outputs image data meeting the total of the resolution parameter. When the main controller receives the video data sent from the graphics card, the image data are divided in accordance with the resolution parameters of all the display devices into frames corresponding to the display devices and outputted to the corresponding image output ports. Accordingly, the automatic split-screen controller can automatically detect and drive a plurality of display devices to demonstrate split screens of image data, getting rid of the tedious and complicated procedure in setting up required parameters through the driver and rendering a convenient operation.

### BRIEF DESCRIPTION OF THE DRAWINGS

FIG. 1 is a schematic diagram showing an architecture of a computer equipped with a graphics card and two display devices in connection with an automatic split-screen controller in accordance with the present invention;

FIG. 2 is a functional block diagram of the automatic split-screen controller in FIG. 1;

FIG. 3 is a flow chart of an automatic frame dividing process in accordance with the present invention;

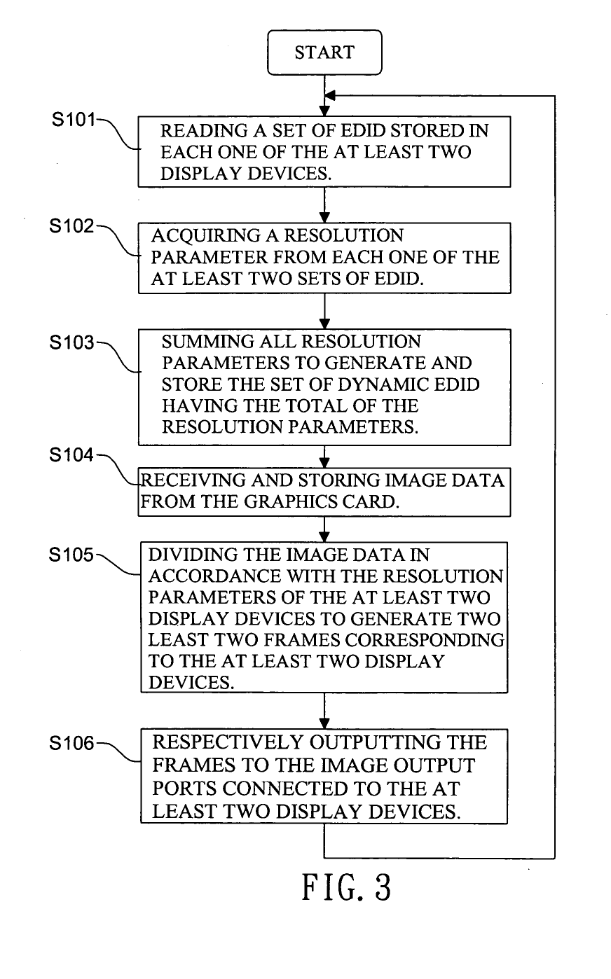

FIG. 4 is a schematic diagram showing a full-screen image data divided into two horizontal frames; and

FIG. 5 is a schematic diagram showing a full-screen image data divided into two vertical frames.

### DETAILED DESCRIPTION OF THE INVENTION

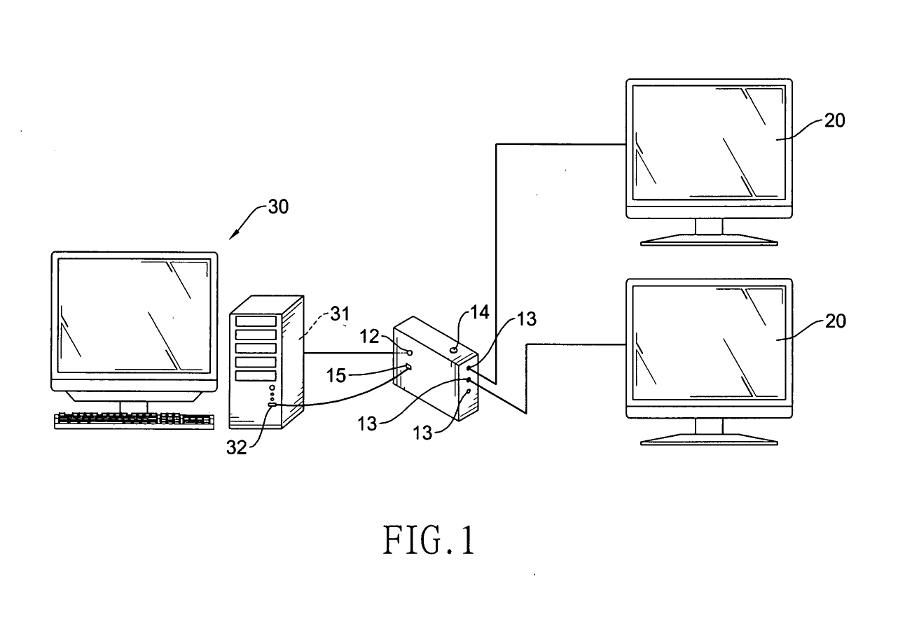

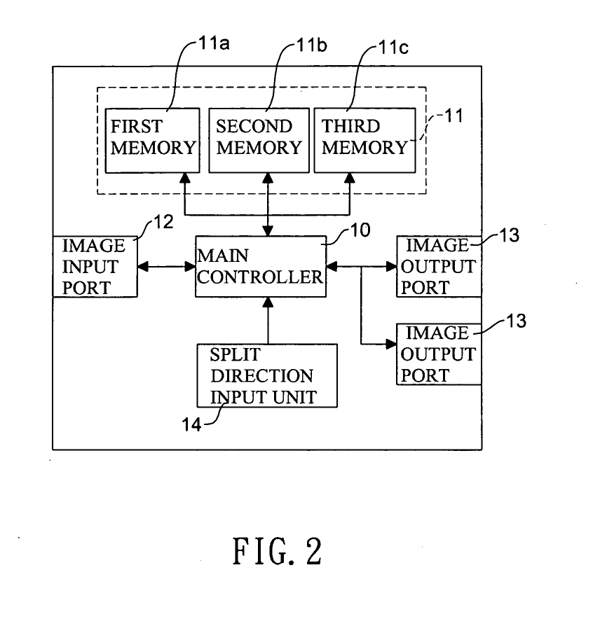

With reference to FIG. 1, an automatic split-screen controller in accordance with the present invention is adapted to connect with a computer 30 and two display devices 20. With reference to FIG. 2, the automatic split-screen controller has a main controller 10, a memory unit 11, an image input port 12 and a plurality of image output ports 13.

The main controller 10 is built in with an automatic frame dividing process. The memory unit 11 is electrically connected with the main controller 10. In the present invention, the memory unit 11 has a first memory 11a and a second memory 11b. The first memory 11a serves to store a dynamic EDID. The second memory 11b serves to store image data in a unit of block.

The image input port 12 is electrically connected with the main controller 10 and is adapted to connect with an output port of a graphics card 31. The image input port 12 complies with the Digital Visual Interface (DVI) standard or the DP standard, such as DVI-D (digital) or DVI-A (analog) standard.

The image output ports 13 are electrically connected with the main controller 10 and are electrically and respectively connected with the corresponding input ports of the display devices 20. The image output ports 13 comply with the Digital Visual Interface (DVI) standard or the DP standard, such as DVI-D (digital) or DVI-A (analog) standard.

The main controller 10 automatically detects if each one of the image output ports 13 has been connected with the corresponding display device 20. If determining that at least two of the image output ports 13 have been connected with the display device 20 and the image input port 12 has been connected with the graphics card 31, the main controller 10 executes an automatic frame dividing process. In the present embodiment, there are two display devices 20 connected with two image output ports 13. The automatic frame dividing process has the following steps of:

reading a set of EDID stored in each one of the at least two display devices (S101);

acquiring a resolution parameter from each one of the at least two sets of EDID (S102);

summing all resolution parameters to generate and store the set of dynamic EDID having the total of the resolution parameters in the first memory (S103);

outputting the set of dynamic EDID generated in the step of summing all resolution parameters to the graphics card (S104);

receiving and storing image data from the graphics card (S105); in the present embodiment, to enhance image data receiving efficiency, block is used as a receiving unit;

dividing the image data in accordance with the resolution parameters of the at least two display devices to generate two least two frames corresponding to the at least two display devices (S106); and

respectively outputting the frames to the image output ports connected to the at least two display devices (S107).

The present invention can automatically detect the number of the connected display devices 20 and read the set of EDID stored in each one of the display devices. The graphics card 31 outputs image data with high resolution based on the set of dynamic EDID generated by the main controller 10 and sent to the graphics card 31. The main controller 10 then divides the image data into frames respectively corresponding to the resolution parameters of the display devices 20 so as to provide each one of the display device 20 the corresponding frame. Accordingly, the present invention can get rid of the trouble that users have to manually set up the parameters required by the split-screen controller.

In some split-screen applications requiring that a plurality of display devices 20 are horizontally or vertically aligned, the main controller 10 further has a split direction input unit 14 in response to that need. Alternatively, the main controller 10 is connected with a switch button for user to choose a split direction of split screens in accordance with the alignment of the display devices 20.

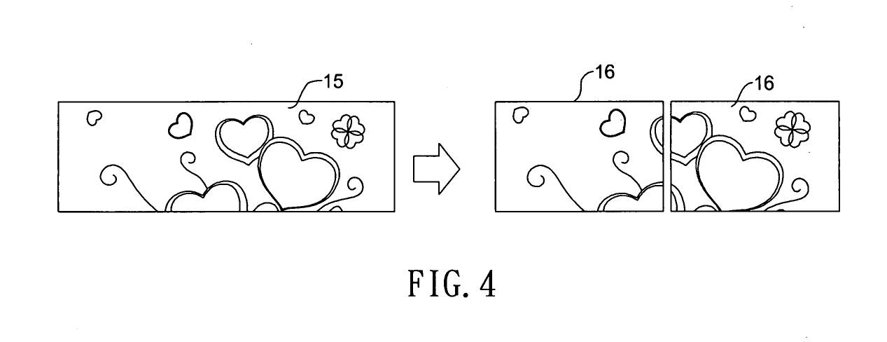

With reference to FIG. 4, the automatic split-screen controller is connected with two display devices 20 that are aligned horizontally. If the resolution parameters of the two display devices are all 1280×1024, the total resolution parameter outputted by the main controller 10 and received by the graphics card 31 is 2560×1024, and image data having the resolution 2560×1024 are outputted to the main controller 10. The main controller 10 then divides the image data 15 in accordance with resolution parameters of the two display devices 20 and a vertical split direction set up by the split direction input unit 14 to generate two identical frames 16. Each one of the two frames 16 has the resolution 1280×1024 and is outputted to the corresponding display device 20.

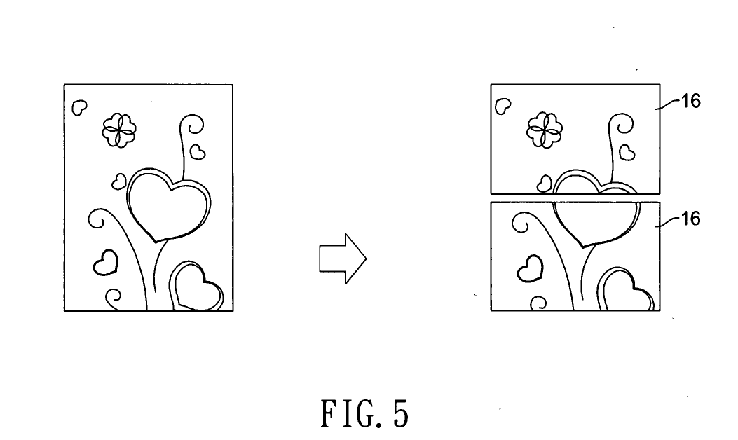

With reference to FIG. 5, the automatic split-screen controller is connected with two display devices 20 that are aligned vertically. The main controller 10 divides the image data 15 in accordance with the resolution parameters of the two display devices 20 and a horizontal split direction set up by the split direction input unit 14 to generate two identical frames 16. Each one of the frame 16 has the resolution 1280×1024 and is outputted to the corresponding display device 20.

Every display device 20 has a bezel surrounding a screen. The bezel becomes an issue in generating discontinuous portions of bordering areas of split screens. In other words, when all split screens are pieced together, they fail to look the same as the original image data before splitting. Hence, the main controller 10 further has a user interface for users to set a size of bezel, and the memory unit 11 further has a third memory 11c for storing the size of bezel. The automatic split-screen controller further has a USB interface 15 to serve as the user interface. After the USB interface 15 is connected with a corresponding USB socket 32 of the computer 30 through a cable, the user interface is generated on the computer 30 in collaboration with an application program. The size of bezel is inputted to the third memory 11c of the automatic split-screen controller through the USB interface.

In the step S103 of the automatic frame dividing process, the main controller 10 adds the size of bezel, for example 40 pixels (20 pixels for each side), stored in the third memory 11c to the total of the resolution parameters to provide the image data with a higher resolution. Given FIG. 4 as an example, image data having a resolution (2560+40)×1024 are outputted. When the main controller 10 receives and horizontally or vertically divides the image data into multiple frames 16, half of the size of bezel is respectively subtracted from the resolution each of the abutting frames 16. Therefore, with reference to FIG. 5, when image data are divided into multiple frames for the split-screen display, the bordering portions of the split screens taking the bezel issue into account are continuous and look like the original image data.

To further prevent an output capacity of the graphics card from limiting the number of the display devices being used, the main controller 10 reduces the corresponding pixels in the horizontal font (back) porch or the vertical front (back) porch of the EDID from 300 pixels to 1 pixel or 2 pixels in the step S103 of the automatic frame dividing process. Thus, image data transmitted from the graphics card 31 to the main controller 10 can be reduced to a minimum. After finishing splitting screens in the step S106, the main controller 10 compensates the pixels missing in the divided frames to be outputted in accordance with the horizontal font (back) porch or the vertical front (back) porch so that the display devices 20 can still exhibit complete and normal split screens.

In sum, in comparison with conventional split-screen controllers, the present invention is advantageous in automatically detecting a number of the display device and adjusting to display a full panel of split screens without requiring users to manually set up the required parameters; eliminating the discontinuous bordering area of split screens caused by the bezel issue; and prevent the output capacity of the graphics card from limiting the number of the display devices being used.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An automatic split-screen controller, comprising:
a main controller built in with an automatic frame dividing process for automatically dividing a plurality of image frames;
a memory unit electrically connected with the main controller for storing a set of dynamic extended display identification data (EDID) having horizontal front porch, horizontal back porch, vertical front porch and vertical back porch, and for storing image data;
an image input port electrically connected with the main controller and adapted to connect with an output port of a graphics card;
a plurality of image output ports electrically connected with the main controller, each one of the image output ports adapted to connect with an input port of one of a plurality of display devices to output one of the divided image frames to the input port of the display device;
wherein after automatically detecting that at least two of the image output ports are connected with the corresponding display devices and the image input port is connected with the graphics card, the main controller executes the automatic frame dividing process having steps of:
reading a set of EDID stored in each one of the at least two display devices;
acquiring a resolution parameter from each one of the at least two sets of EDID;
summing all resolution parameters to generate and store the set of dynamic EDID having the total of the resolution parameters in the first memory;
outputting the set of dynamic EDID generated in the step of summing all resolution parameters to the graphics card;
receiving and storing image data from the graphics card;
dividing the image data in accordance with the resolution parameters of the at least two display devices to generate at least two frames corresponding to the at least two display devices; and
respectively outputting the frames to the image output ports connected to the at least two display devices.

2. The automatic split screen controller as claimed in claim 1, wherein the main controller is further electrically connected with a split direction input unit for selecting a dividing direction of the image data; when performing the step of dividing the image data, the main controller divides the image data in accordance with the selected dividing direction of the image data.

3. The automatic split screen controller as claimed in claim 1, wherein the main controller further has a user interface adapted to set up a size of bezel, the memory unit further has a third memory adapted to store the size of bezel.

4. The automatic split screen controller as claimed in claim 2, wherein the main controller further has a user interface adapted to set up a size of bezel, the memory unit further has a third memory adapted to store the size of bezel.

5. The automatic split screen controller as claimed in claim 3, wherein the main controller further adds the size of bezel to the total of the resolution parameters in the step of summing all resolution parameters to generate the set of dynamic EDID having the total of the resolution parameters for the graphics card.

6. The automatic split screen controller as claimed in claim 4, wherein the main controller further adds the size of bezel to the total of the resolution parameters in the step of summing all resolution parameters for the graphics card.

7. The automatic split screen controller as claimed in claim 1, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

8. The automatic split screen controller as claimed in claim 2, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

9. The automatic split screen controller as claimed in claim 3, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

10. The automatic split screen controller as claimed in claim 4, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

11. The automatic split screen controller as claimed in claim 5, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

12. The automatic split screen controller as claimed in claim 6, wherein the main controller further stores a reduced number of pixels corresponding to a period of each of the horizontal front porch, the horizontal back porch, the vertical front porch and the vertical back porch in the set of dynamic EDID when performing the step of summing all resolution parameters.

13. The automatic split screen controller as claimed in claim 1, wherein the memory unit has:
a first memory storing the set of dynamic EDID; and
a second memory storing the image data stored in a unit of block.

14. The automatic split screen controller as claimed in claim 2, wherein the memory unit has:
a first memory storing the set of dynamic EDID; and
a second memory storing the image data stored in a unit of block.

15. The automatic split screen controller as claimed in claim 11, wherein the memory unit has:
a first memory storing the set of dynamic EDID; and
a second memory storing the image data stored in a unit of block.

16. The automatic split screen controller as claimed in claim 12, wherein the memory unit has:
a first memory storing the sets of dynamic EDID; and
a second memory storing the image data stored in a unit of block.

17. The automatic split screen controller as claimed in claim 1, wherein the image input ports and each one of the image output port complies with a digital visual interface standard.

18. The automatic split screen controller as claimed in claim 2, wherein the image input ports and each one of the image output port complies with a digital visual interface standard.
